(19) United States
(12) Patent Application Publication
(10) Pub. No.: US 2007/0238574 A1
(43) Pub. Date: Oct. 11, 2007

(54) Multi-speed transmission

(75) Inventor: Gerhard Gumpoltsberger, Friedrichshafen (DE)

Correspondence Address: DAVIS & BUJOLD, P.L.L.C., 112 PLEASANT STREET, CONCORD, NH, 03301, US

(73) Assignee: ZF Friedrichshafen AG, Friedrichshafen (DE)

(21) Appl. No.: 11/705,114

(22) Filed: Feb. 9, 2007

(30) Foreign Application Priority Data
Feb. 14, 2006 (DE) 10 2006 006 623.5

(51) Int. Cl. F16H 3/44

(52) U.S. Cl. 475/284

(57) ABSTRACT

A multi-speed transmission with forward and reverse gears having input and output shafts, planetary gearsets, other shafts and control elements. The input shaft is connected to the sun gear of planetary gearset (P2) and is connected to shaft (3) and to shaft (4). Shaft (3) is connected to the carrier of planetary gearset (P1) and the ring gear of planetary gearset (P2) and is coupled to the housing. Shaft (4) is connected to the sun gear of planetary gearset (P1) and is coupled to the housing. The shaft (5) is connected to the ring gear of planetary gearset (P3) and is coupled to shaft (6), which is connected to the carrier of planetary gearset (P2). The output shaft is connected to the carrier of planetary gearset (P3), and the ring gear of planetary gearset (P1). The sun gear of planetary gearset (P3) is connected to the housing.

This application claims priority from German Application Serial No. 10 2006 006 623.5 filed Feb. 14, 2006.

### FIELD OF THE INVENTION

The present invention relates to a multi-speed transmission in planetary design, particularly an automatic transmission for a motor vehicle.

### BACKGROUND OF THE INVENTION

Prior art automatic transmissions, particularly for motor vehicles, comprise planetary gearsets, which are shifted using friction and/or control elements, such as clutches and brakes, and which are typically connected to a starting element that is subject to a slip effect and optionally provided with a lock-up clutch, for example a hydrodynamic torque converter or a fluid clutch.

This type of transmission is described in EP 0 434 525 A1. It substantially comprises one input shaft and one output shaft, which are arranged parallel to each other; a double planetary gearset concentric with the output shaft, and five control elements in the form of three clutches and two brakes; the selective operation of which in pairs determines the different gear ratios between the input shaft and output shaft. This transmission has a front-mounted gearset and two power paths so that six forward gears are obtained by selective engagement in pairs of the five control elements.

In the first power path, two clutches are required for transmitting the torque from the front-mounted gearset to two elements of the double planetary gearset. These elements are substantially arranged in the direction of power flow behind the front-mounted gearset in the direction of the double planetary gearset. In the second power path, a further clutch is provided, which detachably connects this path with a further element of the double planetary gearset. The clutches are arranged such that the inner disk carrier forms the output end.

From the published prior art U.S. Pat. No. 6,139,463 a compact multi-speed transmission in planetary design, particularly for a motor vehicle, is known, which has two planetary gearsets and one front-mounted gearset, as well as three clutches and two brakes. In this known multi-speed transmission, two clutches C-1 and C-3 are provided in a first power path for transmitting the torque from the front-mounted gearset to the two planetary gearsets. The outer disk carrier and/or the cylinder or piston and pressure compensation sides of the clutch C-3 are connected to a first brake B-1. Moreover, the inner disk carrier of the third clutch C-3 is connected to the cylinder and/or piston and pressure compensation sides of the first clutch C-1. The inner disk carrier of the first clutch C-1 is arranged on the output side and connected to a sun gear of the third planetary gearset.

From DE 199 49 507 A1 by the Applicant, a multi-speed transmission is also known of which two non-shiftable, front-mounted gearsets are provided on the drive shaft which, on the output side, generate two rotational speeds. In addition to the rotational speed of the input shaft, it can be selectively switched by closing the control elements to a shiftable double planetary gearset acting upon the output shaft such that, for changing from one gear to the next higher or lower gear of the two actuated control elements, only one control element must be engaged or disengaged.

DE 199 12 480 A1 discloses an automatically shiftable motor vehicle transmission with three spider-mounted planetary gearsets as well as three brakes and two clutches for switching between six forward gears and one reverse gear and with one drive shaft and one output shaft. The automatically shiftable motor vehicle transmission is configured such that the drive shaft is directly connected to the sun gear of the second planetary gearset and that the drive shaft can be connected, via the first clutch, to the sun gear of the first planetary gearset and/or, via the second clutch, to the spider of the first planetary gearset. Additionally or alternatively, the sun gear of the first planetary gearset can be connected, via the first brake, to the transmission housing and/or the spider of the first planetary gearset can be connected, via the second brake, to the housing and/or to the sun gear of the third planetary gearset, via the third brake.

DE 102 13 820 A1 discloses a multi-speed automatic transmission, comprising a first input path T1 of a first speed ratio, an input path T2, which has a larger speed ratio than the input path T1; a planetary gearset of four elements, whereby the four elements are a first element; a second element; a third element, and a fourth element following an order of elements on a speed diagram; a clutch C-2 transmitting a rotation from the input path T2 to the first element S3; a clutch C-1 transmitting the rotation from the input path T2 to the fourth element S2; a clutch C-4 transmitting a rotation from the input path T1 to the first element; a clutch C-3 transmitting the rotation from the input path T1 to the second element C3; a brake B-1 engaging the fourth element; a brake B-2 engaging the second element, and an output member coupled with the third element R3.

Within the scope of DE 101 15 983 A1 by the Applicant, a multi-speed transmission is described comprising a drive shaft that is connected to a front-mounted gearset; an output shaft that is connected to a rear-mounted gearset, and a maximum of seven control elements through the selective shifting of which at least seven forward gears can be shifted without range shifting. The front-mounted gearset is formed by a front-mounted planetary gearset or a maximum of two non-shiftable, front-mounted planetary gearsets connected to the first front-mounted planetary gearset, where the rear-mounted gearset is configured as a two-carrier, four-shaft transmission with two shiftable rear-mounted, planetary gearsets and has four free shafts. The first free shaft of this two-carrier four-shaft transmission is connected to the first control element; the second free shaft with the second, and third control elements; the third free shaft with the fourth and fifth control elements, and the fourth free shaft is connected to the output shaft. According to the invention, a multi-step transmission with a total of six control elements is proposed, which additionally connect the third free shaft or the first free shaft of the rear-mounted gearset to a sixth control element. For a multi-step transmission with a total of seven control elements, according to the invention, it is proposed that the third free shaft is additionally connected to a sixth control element D′ and the first free shaft additionally to a seventh control element.

The scope of DE 101 15 987 by the Applicant describes a multi-step transmission with at least seven gears. In addition to the input shaft and output shaft, this transmission comprises a non-engageable, front-mounted gear and an engageable, rear-mounted gear in the form of a two-fixed-link, four-shaft transmission. The front-mounted gear comprises a first planetary gearset in addition to which the input rotational speed of the input shaft also provides a second rotational speed, which may optionally be shifted to the rear-mounted gear. The rear-mounted gear comprises two engageable, planetary gearsets, which can shift at least seven gears using the six control elements forming two power paths. During each gearshift, range shifting is advantageously avoided. A 9-gear multi-speed transmission is furthermore known from DE 29 36 969. It comprises eight control elements and four gearsets.

Prior art automatic vehicle transmissions in planetary design, in general, have been described on many occasions and undergo continuous development and improvements. These transmissions should have a sufficient number of forward gears as well as one reverse gear and a gear ratio excellently suited for motor vehicles with a high overall spread as well as favorable progressive ratios. Moreover, they should allow a high starting gear ratio in the forward direction and include a direct gear and additionally be suited for use both in passenger cars and in commercial vehicles. In addition, these transmissions should have a low complexity, in particular require a small number of control elements, and avoid double-shifts when shifting sequentially so that only one control element is always engaged when shifting in defined gear groups.

It is, therefore, the object of the present invention to propose a multi-speed transmission of the type mentioned above in which the design complexity is optimized and the efficiency in the main driving gears with regard to drag and gearing losses is improved. Secondly, it is intended that low torque acts on the control elements and planetary gearsets in the multi-speed transmission, according to the invention, and that the rotational speeds of the shafts, control elements and planetary gearsets be kept as low as possible. In addition, the required number of gears and spread of the gear ratios should also be maintained advantageously implementing six forward gears and at least one reverse gear. Lastly, the transmission should be suitable for any design in a vehicle, particularly for a frontal-transverse configuration.

### SUMMARY OF THE INVENTION

Accordingly, a multi-speed transmission having a planetary design is proposed, which has one input shaft and one output shaft, which are arranged in a housing. Moreover, at least three planetary gearsets (hereinafter referred to as the first, second and third planetary gearsets), at least six rotatable shafts (hereinafter referred to as the input shaft, output shaft, third, fourth, fifth and sixth shafts), and at least five control elements, comprising brakes and clutches, are provided. The selective engagement of these components creates different gear ratios between the input shaft and the output shaft so that preferably six forward gears and one reverse gear can be shifted.

The input shaft is permanently connected to the sun gear of the second planetary gearset and can be detachably connected, via a clutch, to the third shaft and, via a further clutch, to the fourth shaft. The third shaft is permanently connected to the carrier of the first planetary gearset and the ring gear of the second planetary gearset, and can be coupled to the housing via a brake. Additionally, the fourth shaft is permanently connected to the sun gear of the first planetary gearset and can be coupled to the housing via a further brake.

The fifth shaft is permanently connected to the ring gear of the third planetary gearset and can be detachably connected, via a clutch, to the sixth shaft, which is permanently connected to the carrier of the second planetary gearset.

According to the invention, the output shaft is permanently connected to the carrier of the third planetary gearset and the ring gear of the first planetary gearset is non-rotatably connected to the housing via a non-rotating shaft.

The configuration of the multi-speed transmission, according to the invention, produces suitable gear ratios particularly for passenger cars, as well as a considerable increase of the total spread of ratios of the multi-speed transmission, resulting in improved driving comfort and a significant improvement in fuel economy.

In addition, the multi-speed transmission allows a considerable decrease in complexity due to the low number of control elements, preferably two brakes and three clutches. With the multi-speed transmission, start-up is advantageously possible with a hydrodynamic converter, a hydrodynamic clutch, an external starting clutch or with other suitable external starting elements, according to the invention. It is also conceivable to allow a starting operation with a starting element integrated in the transmission. A control element is preferred, which is actuated in the first gear and in the reverse gear.

In addition, good efficiency in the main driving gears with regard to drag and gearing losses can be achieved with the multi-speed transmission according to the invention.

Furthermore, low torque is present in the control elements and in the planetary gearsets of the multi-speed transmission, thus advantageously reducing wear of the multi-speed transmission. Besides, the low torque makes small dimensions possible, allowing reductions in the required installation space and the corresponding costs. Also, the rotational speeds of the shafts, control elements and planetary gearsets are low.

In addition, the transmission, according to the invention, is designed such that it can be adjusted to different drive train configurations, both in the direction of power flow and with regard to space.

### BRIEF DESCRIPTION OF THE DRAWINGS

The invention will now be described, by way of example, with reference to the accompanying drawings in which:

FIG. 1 is a schematic illustration of a preferred embodiment of a multi-speed transmission according to the invention;

FIG. 2 is an exemplary shifting diagram for the multi-speed transmission according to the invention as apparent from FIG. 1;

FIG. 3 is a diagrammatic view of an embodiment of the inventive multi-speed transmission having a one-way clutch;

FIG. 4 is a diagrammatic view of an embodiment of the inventive multi-speed transmission with an electric machine;

FIG. 5 is a diagrammatic view of a preferred design of the inventive multi-speed transmission having a wear-free brake;

FIG. 6 is a diagrammatic view of a further embodiment of the invention with the input and the output being provided on the same side of the housing;

FIG. 7 is a diagrammatic view of another embodiment of the inventive multi-speed transmission with the crankshaft of the drive motor fixed to the input shaft of the multi-speed transmission and the driving element located behind the multi-speed transmission;

FIG. 8 is a diagrammatic view of an embodiment of the inventive multi-speed transmission having a differential;

FIG. 9 is a diagrammatic view of an embodiment of the inventive multi-speed transmission with a clutch element and a drive motor;

FIG. 10 is a diagrammatic view of an embodiment of the inventive multi-speed transmission with a crankshaft of the drive motor fixed to an input shaft of the multi-speed transmission;

FIG. 11 is a diagrammatic view of an embodiment of the inventive multi-speed transmission having the drive motor communicating with a damper;

FIG. 12 is a diagrammatic view of an embodiment of the inventive multi-speed transmission with a power take-off for driving an additional unit.

### DETAILED DESCRIPTION OF THE INVENTION

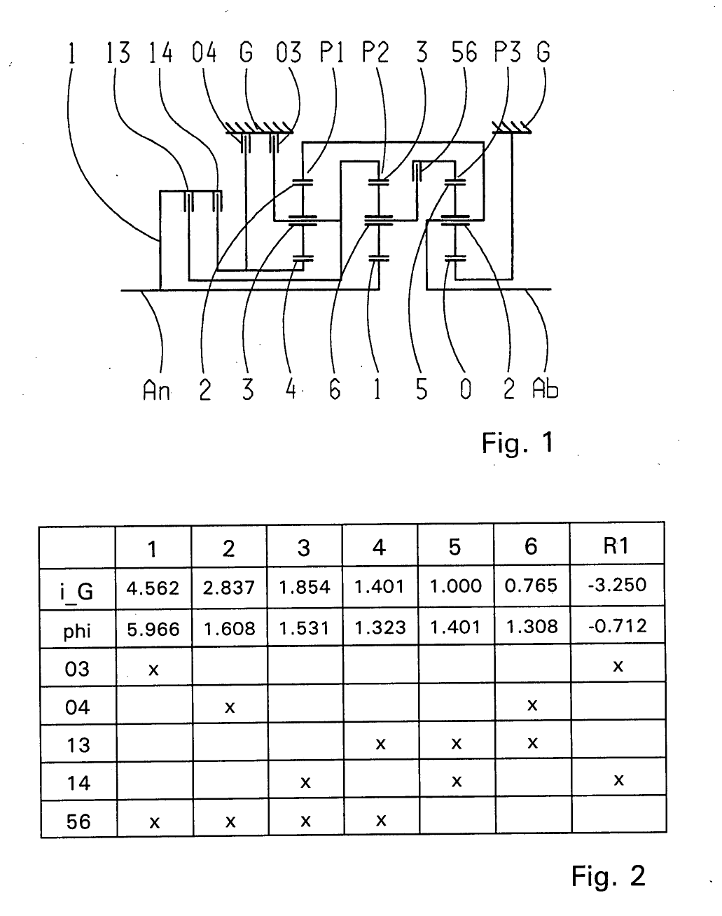

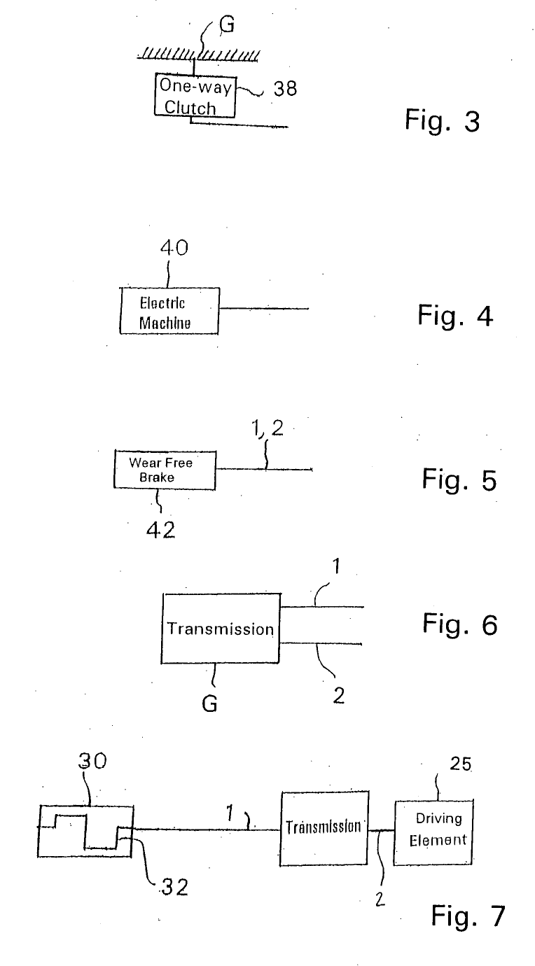

FIG. 1 shows a multi-speed transmission, according to the invention, comprising an input shaft 1 (An) and an output shaft 2 (Ab), which are arranged in a housing G. Three planetary gearsets P1, P2, P3 are provided, which are preferably configured as the negative planetary gearsets and arranged in the sequence P1, P2, P3 in axial direction (and also in the direction of power flow).

As can be seen in FIG. 1, only five control elements, namely two brakes 03, 04 and three clutches 13, 14, and 56, are provided. With these control elements, a selective engagement of preferably six forward gears and one reverse gear can be implemented. The multi-speed transmission has a total of six rotatable shafts, namely shafts 1, 2, 3, 4, 5 and 6, according to the invention.

As apparent from FIG. 1, in the multi-speed transmission, it is provided that the input occurs via the shaft 1, which is permanently connected to the sun gear of the second planetary gearset P2 and can be detachably connected via the clutch 13 to the shaft 3, and via the clutch 14 to the shaft 4, where the shaft 3 is permanently connected to the carrier of the first planetary gearset P1 and the ring gear of the second planetary gearset P2 and can be coupled to the housing G, via the brake 03, and whereby the shaft 4 is permanently connected to the sun gear of the first planetary gearset P1 and can be coupled to the housing G via the brake 04.

Furthermore, the shaft 5 is permanently connected to the ring gear of the third planetary gearset P3 and can be detachably connected via the clutch 56 to the shaft 6, which is permanently connected to the carrier of the second planetary gearset P2.

The output occurs via the shaft 2, which is permanently connected to the carrier of the third planetary gearset P3 and the ring gear of the first planetary gearset P1. Furthermore, the sun gear of the third planetary gearset P3 is non-rotatably connected to the housing G via a shaft 0.

Within the scope of the illustrated embodiments, the clutches 13 and 14 are arranged in front of the first planetary gearset P1 in the sequence of 13, 14 from an axial point of view in the direction of power flow and may comprise a common outer disk carrier as the disk clutches. The brakes 04, 03 are arranged in front of the first planetary gearset P1 in the sequence of 04, 03, also from an axial point of view.

The spatial arrangement of the control elements can be arbitrary and is only limited by the dimensions and design.

FIG. 2 exemplifies a shifting diagram of the multi-speed transmission according to the invention as shown in FIG. 1. Two control elements are engaged for each gear. The shifting diagram shows a respective gear ratio i of the individual gear steps and the resulting exemplary progressive ratio phi. Typical stationary gear ratio values of the planetary gearsets P1, P2, P3 are −3.250, −2.255 and −2.491, respectively. The shifting diagram also shows that double-shifts and/or range shifts are avoided when shifting sequentially because two adjoining gear steps have one common control element engaged. It is preferable if the fifth gear is configured as a direct gear.

The first gear results from engaging the brake 03 and the clutch 56, the second gear from engaging the brake 04 and the clutch 56, and the third gear from engaging the clutches 14 and 56. Furthermore, the fourth gear results from engaging the clutch 13 and the clutch 56, the fifth gear from engaging the clutches 13 and 14 and the sixth gear from engaging the brake 04 and the clutch 13. As the shifting diagram illustrates, the reverse gear results from engaging the brake 03 and the clutch 14.

According to the invention, starting up with an integrated control element 03, 56 is possible (IAK), for which particularly the brake 03 is suited, which is required in the first gear and the reverse gear. Depending on the shifting logic, different gear steps may be obtained from the same gear pattern, allowing application-specific and/or vehicle-specific variations.

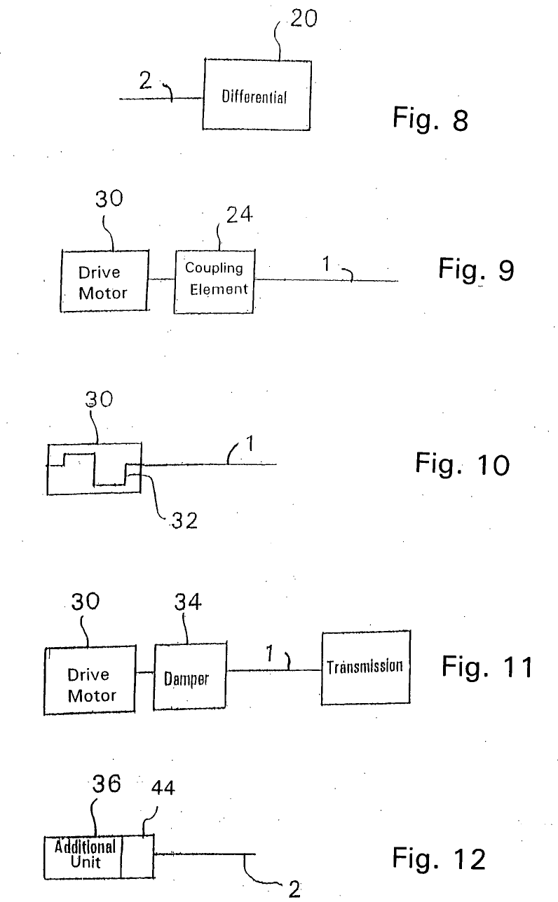

In addition, as shown in FIG. 8, it is possible to provide additional one-way clutch 38 in suitable locations of the multi-speed transmission, for instance between a shaft and the housing or optionally connecting two shafts.

According to the invention, as shown in FIG. 8, an axle differential and/or a transfer case differential 20 may be arranged on the input side or output side. Additionally, as shown in FIG. 6, the input and the output are provided on the same side of the housing G.

Within the scope of an further embodiment, the input shaft 1 may be separated from the drive motor (engine) 30 as needed by a coupling element 24, where the coupling element 24 may be a hydrodynamic converter, a hydraulic clutch, a dry starting clutch, a wet starting clutch, a magnetic powder clutch or a centrifugal clutch. It is also possible, as shown in FIG. 7, to arrange such a driving element in the direction of power flow behind the transmission where, in this case, the input shaft 1 is permanently connected to the crankshaft of the engine, or as shown in FIG. 10, the input shaft 1 may be permanently connected to the crankshaft 32 of the drive motor 30.

The multi-speed transmission, according to the invention, as shown in FIG. 11, also allows the arrangement of a torsional vibration damper 34 between the engine 30 and transmission.

Within the scope of a further embodiment of the invention, as shown in FIG. 5, a wear-free brake 42, such as a hydraulic retarder or electric retarder or the like, may be arranged on the input shaft 1 or the output shaft 2, which is particularly important when the transmission is used in commercial vehicles. Furthermore, as shown in FIG. 12, a power take-off 44 may be provided on each shaft, preferably on the input shaft 1 or the output shaft 2, to drive additional units 36.

The control elements used may be configured as power-shift clutches or brakes. In particular, power-shift clutches or brakes, such as multi-disk clutches, band brakes and/or cone clutches, may be used. Moreover, it is also possible to use positive brakes and/or clutches, such as synchronization devices or claw clutches, as control elements.

A further advantage of the multi-speed transmission presented here is that, as shown in FIG. 4, an electric machine 40 can be arranged on each shaft as a generator and/or additional drive unit.

Of course, any design configuration, particularly any spatial arrangement of the planetary gearsets and the control elements as such, as well as in relation to each other, to the extent they are technically expedient, falls under the scope of protection of the present claims without influencing the function of the transmission as described in the claims, even if these embodiments are not explicitly illustrated in the Figures or mentioned in the description.

### REFERENCE NUMERALS

0 shaft i gear ratio
1 shaft IAK integrated control element
2 shaft phi progressive ratio
3 shaft G housing
4 shaft
5 shaft
6 shaft
03 brake
14 brake
13 clutch
14 clutch
20 differential
24 clutch element
25 driving element
30 drive motor
32 crank shaft
34 damper
36 additional unit
38 one-way clutch
40 electric machine
42 wear-free brake
44 power take-off
56 clutch
P1 planetary gearset
P2 planetary gearset
P3 planetary gearset
An input
Ab output

1-24. (canceled)

25. A multi-speed automatic transmission of a planetary design for a motor vehicle, the transmission comprising:
an input shaft (1) and an output shaft (2) which are arranged in a housing (G);
first, second and third planetary gear set (P1, P2, P3);
at least third, fourth, fifth and sixth rotatable shaft (3, 4, 5, 6); and
at least five control elements (03, 04, 13, 14, 56) including first and second brakes (03, 04) and first, second and third clutches (13, 14, 56), and selective engagement of the at least five control elements (03, 04, 13, 14, 56) creates a plurality of different gear ratios between the input shaft (1) and the output shaft (2) so that at least six forward gears and one reverse gear are implemented;
the input shaft (1) being permanently coupled to a sun gear of the second planetary gear set (P2) and being detachably connected, via the first clutch (13), to the third shaft (3) and, via a second clutch (14), to the fourth shaft (4);
the third shaft (3) being permanently coupled to a carrier of the first planetary gear set (P1) and a ring gear of the second planetary gear set (P2) and being detachably coupled, via the first brake (03), to the housing (G);
the fourth shaft (4) being permanently coupled to a sun gear of the first planetary gear set (P1) and being detachably coupled, via the second brake (04), to the housing (G);
the fifth shaft (5) being permanently coupled to a ring gear of the third planetary gear set (P3) and being detachably coupled, via the third clutch (56), to the sixth shaft (6) permanently coupled to a carrier of the second planetary gear set (P2);
the output shaft (2) being permanently coupled to a carrier of the third planetary gear set (P3) and to a ring gear of the first planetary gear set (P1); and
a sun gear of the third planetary gear set (P3) being rotationally fixed, via a seventh shaft (0), to the housing (G).

26. The multi-speed transmission according to claim 25, wherein the first, the second and the third planetary gear sets (P1, P2, P3) are arranged, in a direction of power flow, in the sequential order of:
the first planetary gear set (P1), the second planetary gear set (P2) and the third planetary gear set (P3).

27. The multi-speed transmission according to claim 25, wherein the first, the second and the third planetary gear sets (P1, P2, P3) are negative planetary gear sets.

28. The multi-speed transmission according to claim 25, wherein the first and the second clutches (13, 14) are arranged, in the direction of power flow, in front of the first planetary gear set (P1) and in the sequential order of:
the first clutch (13) and the second clutch (14).

29. The multi-speed transmission according to claim 25, wherein the first and the second clutches (13, 14) are disk clutches and have a common outer disk carrier.

30. The multi-speed transmission according to claim 25, wherein, when view in a power flow direction from the input shaft, the second and the first brakes (04, 03) are located in front of the first planetary gear set (P1) and the second brake (04) is located in front of the first brake (03).

31. The multi-speed transmission according to claim 25, wherein for the six forward gears, first gear is implemented by engagement of the first brake (03) and the third clutch (56), second gear is implemented by engagement of the second brake (04) and the third clutch (56), third gear is implemented by engagement of the second clutch (14) and the third clutch (56), fourth gear is implemented by engagement of the first clutch (13) and the third clutch (56), fifth gear is implemented by engagement of the first clutch (13) and the second clutch (14), and sixth gear is implemented by engagement of the second brake (04) and the first clutch (13).

32. The multi-speed transmission according to claim 25, wherein the reverse gear is implemented by engagement of the first brake (03) and the second clutch (14).

33. The multi-speed transmission according to claim 25, wherein the transmission includes a one-way clutch.

34. The multi-speed transmission according to claim 25, wherein a one-way clutch is located between at least one of the input shaft (1), the output shaft (2), the third shaft (3), the fourth shaft (4), the fifth shaft (5) and the sixth shaft (6) and the housing (G).

35. The multi-speed transmission according to claim 25, wherein the input shaft (1) and the output shaft (2) are both located on a common side of the housing.

36. The multi-speed transmission according to claim 25, wherein at least one of an axle differential and a transfer case differential is located on one of the input shaft (1) and the output shaft (2).

37. The multi-speed transmission according to claim 25, wherein a coupling element is located between the input shaft (1) and a drive motor.

38. The multi-speed transmission according to claim 37, wherein the coupling element is one of a hydrodynamic converter, a hydraulic clutch, a dry starting clutch, a wet starting clutch, a magnetic powder clutch and a centrifugal clutch.

39. The multi-speed transmission according to claim 25, wherein a coupling element of is located, in a power flow direction, behind the multi-speed transmission, and the input shaft (1) is coupled to a crankshaft of a drive motor.

40. The multi-speed transmission according to claim 25, wherein at least one of the five control elements (03, 56) of the multi-speed transmission initiates starting of the motor vehicle, and the input shaft (1) is fixed to a crankshaft of a drive motor.

41. The multi-speed transmission according to claim 25, wherein a torsional vibration damper is located between the multi-speed transmission and a drive motor.

42. The multi-speed transmission according to claim 25, wherein a wear-free brake is located on at least one of the input shaft (1), the output shaft (2), the third, the fourth, the fifth and the sixth rotatable shafts (3, 4, 5, 6).

43. The multi-speed transmission according to claim 25, wherein a power take-off is located on one or more of the input shaft (1), the output shaft (2), the third shaft (3), the fourth shaft (4), the fifth shaft (5) and the sixth shaft (6) for driving an additional unit.

44. The multi-speed transmission according to claim 43, wherein the power takeoff is located on one of the input shaft (1) and the output shaft (2).

45. The multi-speed transmission according to claim 25, wherein each of the at least five control elements (03, 04, 13, 14, 56) is one of a power-shift clutch and an additional brake.

46. The multi-speed transmission according to claim 45, wherein the power-shift clutches and the additional brakes are one of a multi-disk clutch, a band brake and a cone clutch.

47. The multi-speed transmission according to claim 25, wherein each of the at least five control elements (03, 04, 13, 14, 56) is one of a positive brake and a further clutch.

48. The multi-speed transmission according to claim 25, wherein an electric machine is located on at least one of the input shaft (1), the output shaft (2), the third shaft (3), the fourth shaft (4), the fifth shaft (5) and the sixth shaft (6).
